(19) United States
(12) Patent Application Publication
(10) Pub. No.: US 2009/0204369 A1
(43) Pub. Date: Aug. 13, 2009

(54) Control Apparatus and Program

(75) Inventor: Norihiko ASAI, Tajimi-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/367,145

(22) Filed: Feb. 6, 2009

(30) Foreign Application Priority Data
Feb. 8, 2008 (JP) 2008-028544
Feb. 29, 2008 (JP) 2008-049372

(51) Int. Cl. G06F 15/00

(52) U.S. Cl. 702/186

(57) ABSTRACT

A control apparatus is provided. The control apparatus includes: a performance storage unit which stores performance information of a device corresponding to an installed control program; a setting unit which sets condition information for a default device; a condition storage unit which stores the condition information set by the setting unit; a comparing unit which compares the condition information stored in the condition storage unit with the performance information stored in the performance storage unit; and a selecting unit which selects the default device based on a comparison result of the comparing unit.

### CROSS-REFERENCE TO RELATED APPLICATION

This application claims priority from Japanese Patent Application Nos. 2008-028544, filed on Feb. 8, 2008 and 2008-049372, filed on Feb. 29, 2008, the entire subject matter of which is incorporated herein by reference.

### TECHNICAL FIELD

Aspects of the present invention relates to a control apparatus and a program for setting a default device.

In the related art, a user has to set a default device when installing a device, which needs a complicated setting operation.

JP-A-2005-11054 describes a method including setting setup conditions (for example, the maximum size of a printing sheet and printing speed) in advance and automatically setting a default device according to the setup conditions.

However, in the related-art method, the setup conditions are set in advance, and a default device suitable for a user may not be selected depending on the use condition.

Additionally, in the related-art method, a monitoring controller acquires information of the device. However, in some cases, the information of the device can not be acquired due to some errors.

Even though the information of the device is acquired, in some cases, the monitoring controller can not properly utilize the information, thereby failing to set a default device.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to provide a method capable of allowing the user to select setup conditions such that the user can select a default device suitable for the use conditions.

Additionally, it is another aspect of the preset invention to provide a method capable of notifying performance information of a device connected thereto to a user such that the user can select a device having a desired performance as a default device.

According to an exemplary embodiment of the present invention, there is provided a control apparatus including: a performance storage unit which stores performance information of a device corresponding to an installed control program; a setting unit which sets condition information for a default device; a condition storage unit which stores the condition information set by the setting unit; a comparing unit which compares the condition information stored in the condition storage unit with the performance information stored in the performance storage unit; and a selecting unit which selects the default device based on a comparison result of the comparing unit.

According to another exemplary embodiment of the present invention, there is provided a computer-readable medium having a computer program stored. thereon and readable by a computer including a performance storage unit which stores performance information of a device corresponding to a control program installed in the computer, and a condition storage unit which stores condition information for a default device, the computer program, when executed by the computer, causing the computer to perform operations including: setting the condition information and storing in the condition storage. unit; comparing the condition information stored in the condition storage unit with the performance information stored in the performance storage unit; and selecting the default device based on a result of the comparing.

According to another exemplary embodiment of the preset invention, there is provided a control apparatus including: a performance storage unit which stores performance information of a plurality of devices; an indicating unit which indicates the performance information; and a selecting unit which selects, based on an input from an outside, a default device from among the plurality of devices, the performance information of which is indicated by the indication unit.

According to another exemplary embodiment of the present invention, there is provided a computer-readable medium having a computer program stored thereon and readable by a computer including a performance storage unit which stores performance information of a plurality of devices, the computer program, when executed by the computer, causing the computer to perform operations including: indicating the performance information; and selecting, based on an input from the outside, a default device from among the plurality of devices, the performance information of which is indicated by the indicating.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a diagram illustrating a connection configuration between a PC and a plurality of printers;

FIG. 2 is a block diagram illustrating a hardware configuration of the PC and the printers in a control system;

FIG. 3 is a flowchart illustrating a method of setting a default printer when a printer driver is installed according to a first exemplary embodiment;

FIG. 4 is a flowchart illustrating a method of acquiring and registering performance information of a printer according to the first exemplary embodiment;

FIG. 5 is a diagram illustrating an example of the performance information of first to third printers stored in an HDD;

FIG. 6 is a diagram illustrating a window displayed on a display when condition information is set;

FIG. 7 is a flowchart illustrating a method of setting a default printer when a printer driver is installed according to a second exemplary embodiment;

FIG. 8 is a flowchart illustrating a method of setting a default printer when a printer driver is installed according to a third exemplary embodiment; and

FIG. 9 is a flowchart illustrating a method of acquiring and registering performance information of a first printer according to the third exemplary embodiment.

### DETAILED DESCRIPTION

Hereinafter, a control apparatus and a control system applied with a program according to an exemplary embodiment of the present invention will be described in detail.

### <Overall Configuration of Control System>

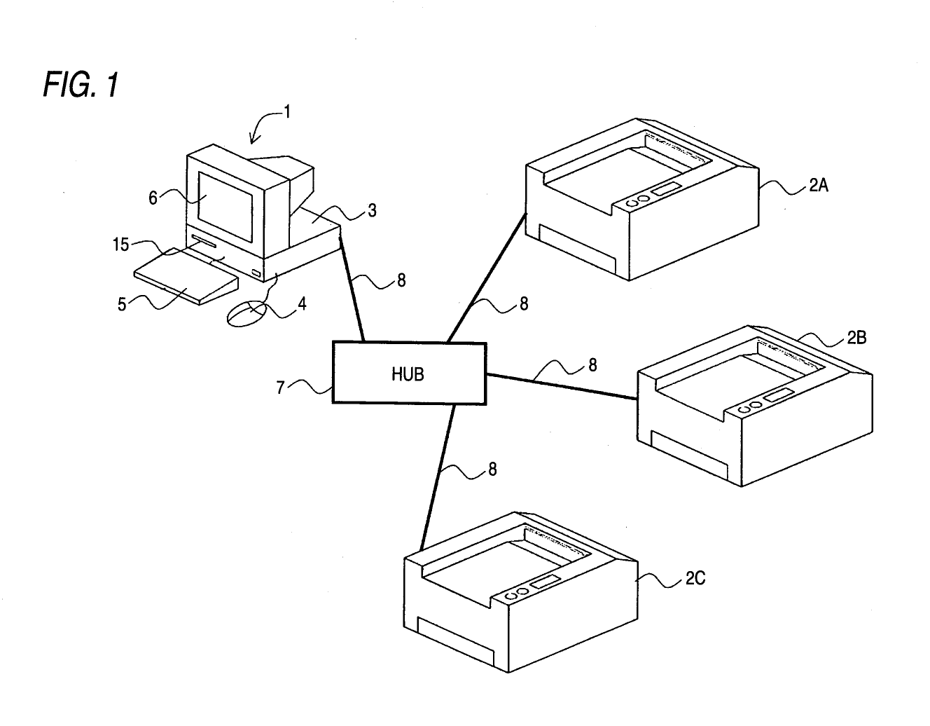

FIG. 1 is a diagram illustrating connection among a personal computer (PC) 1 and first to third printers 2A to 2C connected to the PC 1 in the control system.

Suffixes ‘A’, ‘B’, and ‘C’ added to the first to third printers 2A, 2B, and 2C are used for identifying each of the printers. When the printers connected to the PC 1 are not necessary to be discriminated, they are simply referred to as printers 2.

The PC 1 includes a main body 3, a mouse 4 and a keyboard 5 and a display 6. The mouse 4, the keyboard 5, and the display 6 are connected to the main body 3.

The main body 3 of the PC 1 is connected to a HUB 7 through a LAN cable 8. The HUB 7 is a relay device for connecting a plurality of printers 2 and the PC 1. The HUB 7 is connected to the printers 2 by a plurality of LAN cables 8, respectively, and the printers 2 are connected to the PC 1 through the HUB 7.

In this exemplary embodiment, three printers 2 are connected to the HUB 7. However, the number of printers 2 is not limited to three. In addition, a connection unit that connects the printer 2 and the PC 1 is not limited to the LAN cable 8. That is, the printers 2 and the PC 1 may be connected to each other by a wireless communication system, such as a wireless LAN or infrared communication. Alternatively, the printer 2 may be directly connected to the PC 1 by, for example, a USB cable.

### <Hardware Configuration of Control System>

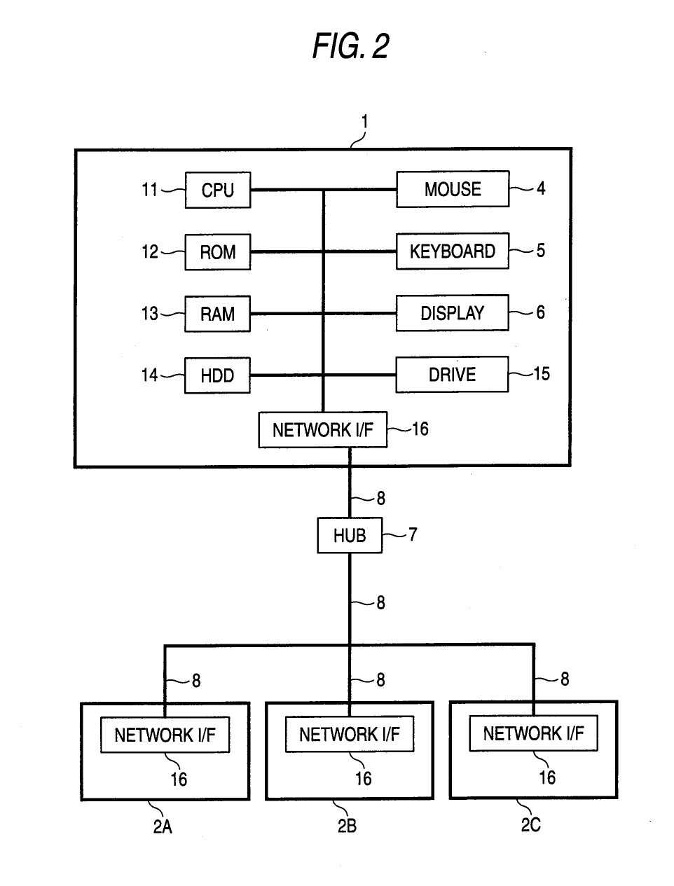

FIG. 2 is a block diagram illustrating the hardware configuration of the PC 1 and the printers 2 in the control system.

A control program according to the first exemplary embodiment is installed in the PC 1, which is an information terminal.

The PC 1 includes a central processing unit (CPU) 11 that executes various processes, a read only memory (ROM) 12 that stores, for example, a starting operation program (BIOS) executed by the CPU 11 during the startup of the PC 1, and a random access memory (RAM) 13 that is used as a storage area when the CPU 11 executes various processes.

The PC 1 further includes a hard disk drive (HDD) 14 that stores an operating system (OS) and various programs to be executed by the CPU 11, and a read drive 15 that reads data stored in a CD-ROM or a DVD-ROM inserted from the outside.

The HDD 14 stores performance information and condition information of the printers 2 according to the first exemplary embodiment.

Herein, the performance information indicates the performance or function of each of the printers 2. Specifically, the performance information includes, for example, the printing speed, a maximum printing resolution, the size of a printing sheet, capability of color printing, capability of double-sided printing, and capability of N-in-1 printing of each of the printers 2. The performance information is stored for each printer 2 having a printer driver (control program) thereof installed in the PC 1.

When a printer driver for a printer 2 is installed in the PC1, the performance information of the printer 2 is stored in the HDD 14. If the performance information of a printer 2 is not stored in the HDD 14, which has been connected to the PC 1, the performance information can be read from a CD-ROM having a printer driver corresponding to the printer 2 stored therein and then stored in the HDD 14. That is, the performance information of the printers that are on the market is stored in the CD-ROM as a database.

In addition, the PC1 may access a server (not shown) storing the performance information of the printer 2 through an external LAN, and acquire the performance information of the printer 2 connected to the PC 1 from the server. Further, the performance information of printers 2 that will be put on sale soon may be registered in the server having the performance information of the currently used printers stored therein. In this case, it is possible to further improve user convenience.

The condition information indicates a priority order of the performance information (condition information item), and is used to automatically select a default printer. The condition information can be uniquely set by the user. The user sets the condition information such that the CPU 11 can determine a default printer having desired function information among the printers 2. In this way, it is possible to set one of the printers 2 having a desired function as the default printer.

The PC 1 includes a network interface 16 for connecting the printers 2. Each of the printers 2 also has the network interface 16 corresponding to the interface of the PC 1. The interface may be a USB interface, a printer port interface, or a wireless interface using a wireless LAN or infrared communication.

The mouse 4, the keyboard 5, the display 6, and the drive 15 are connected to the CPU 11, and serve as user interfaces.

### <Operation of First Exemplary Embodiment>

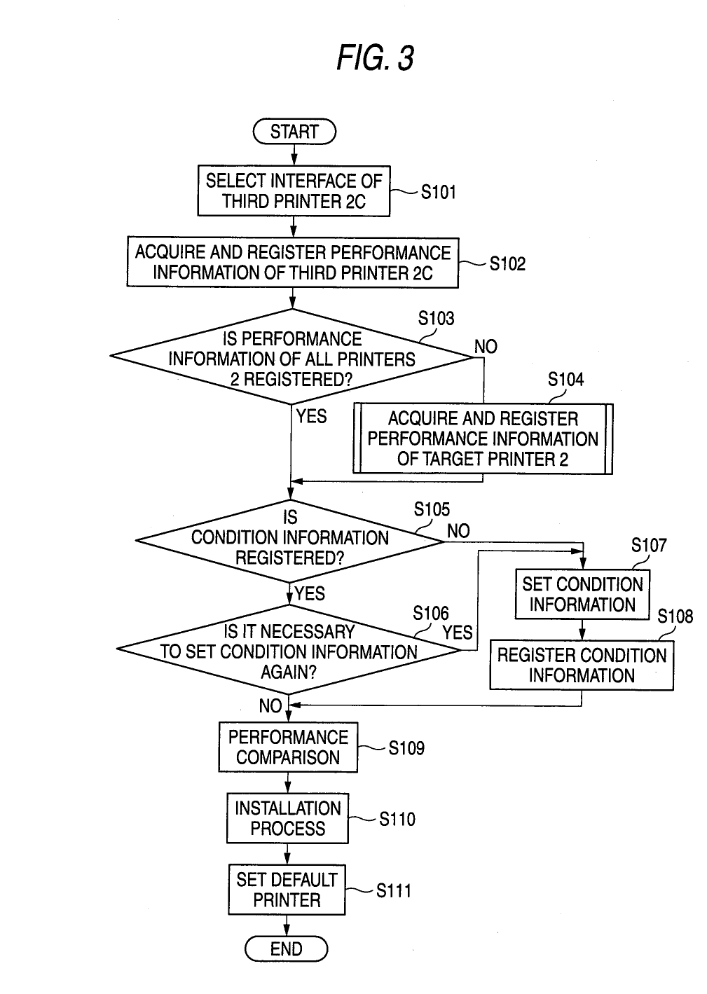

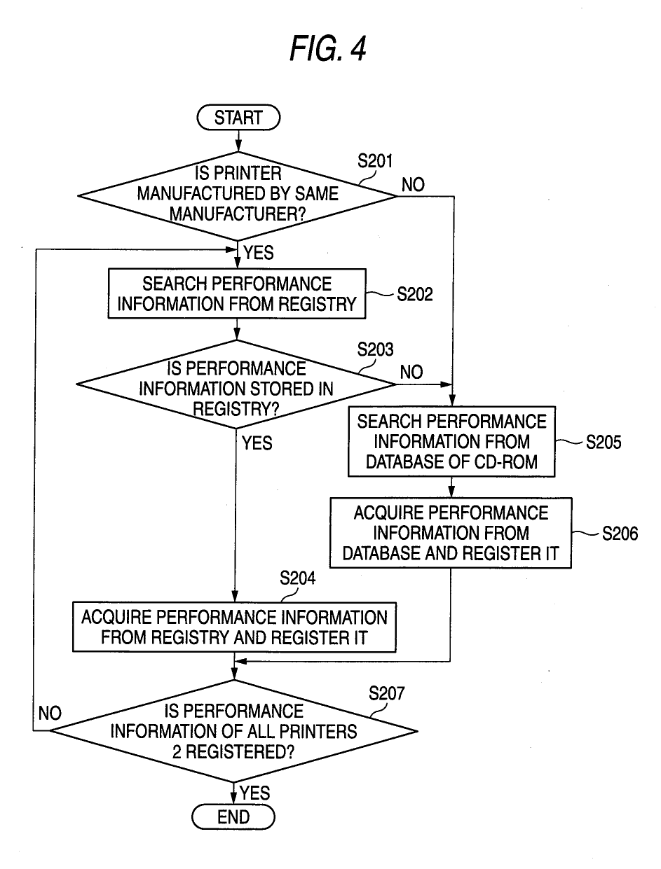

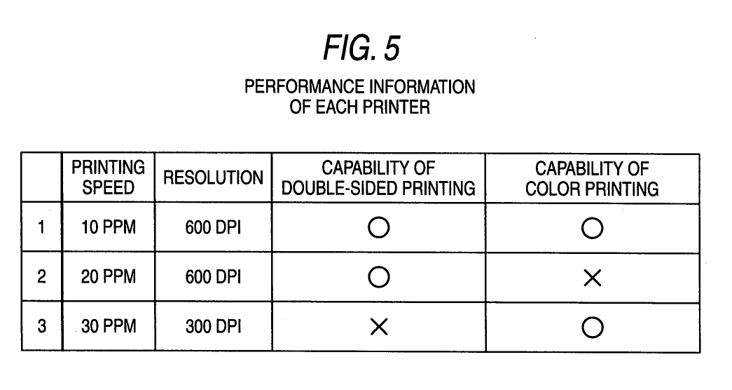

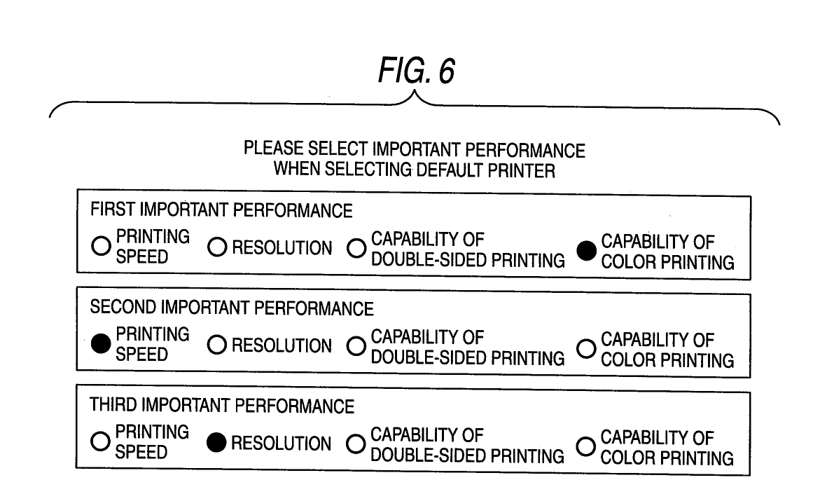

FIG. 3 is a flowchart illustrating a method of setting a default printer when a printer driver is installed according to a first exemplary embodiment. FIG. 4 is a flowchart illustrating a method of acquiring and registering the performance information of a printer 2 according to the first exemplary embodiment. FIG. 5 is a diagram illustrating examples of the performance information of the first to third printers 2A, 2B, and 2C stored in the HDD 14. FIG. 6 is a diagram illustrating a window displayed on the display 6 when the condition information is set.

An operation of setting a default printer according to the first exemplary embodiment will be described with reference to FIGS. 3 to 6. In this exemplary embodiment, an operation of installing a printer driver of the third printer 2C in the PC 1 when the printer drivers of the first printer 2A and the second printer 2B have already been installed in the PC 1 will be described.

When the printer driver of the third printer 2C is read from a CD-ROM inserted into the drive 15 and an operation of installing the printer driver starts, as shown in FIG. 3, first, the CPU 11 selects an interface connected to the third printer 2C at operation S101.

In this exemplary embodiment, since the third printer 2C is connected by the network interface 16, the CPU 11 selects the network interface 16. Herein, if other connection methods described above is used, the CPU 11 selects a USB interface or a wireless network interface accordingly.

Next, at operation S102, the CPU 11 acquires the performance information of the third printer 2C, and registers the acquired performance information in the HDD 14. In this exemplary embodiment, the performance information is acquired from the third printer 2C, and then registered in the HDD 14. Herein, the performance information of the third printer 2C may be read from a CD-ROM having a printer driver corresponding to the third printer 2C stored therein, and then stored in the HDD 14. In this case, the performance information should be stored in the CD-ROM.

At operation S103, it is determined whether the performance information of all the printers 2, printer drivers of which have already been installed, is registered in the HDD 14.

If it is determined that the performance information of not all the printers 2 is registered (S103: No), at operation S104, the performance information of a target printer 2 for which performance information is not registered and is necessary, among the printers 2 is acquired and registered.

A method of acquiring and registering the performance information of the target printer 2 at operation S104 is shown in FIG. 4. First, at operation S201, it is determined whether the target printer 2 is manufactured by the same manufacturer as the control apparatus or the program according to this exemplary embodiment. If a plurality of target printers exist, the target printers are processed one by one.

The reason why it is determined at operation S201 whether the manufacturers are the same is described as follows. That is, if the manufacturer of the control apparatus or the program according to this exemplary embodiment is the same as that of the target printer 2, the performance information of the target printer 2 is more likely to be stored in a registry of the control apparatus or the program since the performance information is generally stored in such registry. Therefore, the performance information may be acquired from the registry.

If it is determined at operation S201 that the printer 2 is manufactured by the same manufacturer (S201: Yes), at operation S202, the performance information is searched from the registry.

Next, at operation S203, it is determined whether the performance information of the target printer 2 is stored in the registry. If it is determined that the performance information is stored in the registry (S203: Yes), at operation S204, the performance information of the target printer 2 is acquired from the registry and then registered in the HDD 14.

If it is determined at operation S201 that the target printer 2 is not manufactured by the same manufacturer (S201: No) or it is determined at operation S203 that the performance information of the target printer 2 is not stored in the registry (S203: No), at operation S205, information of the target printer 2 is searched from a database of a CD-ROM.

At operation S206, the information of the target printer 2 is acquired from the database of the CD-ROM, and then registered in the HDD 14.

At operation S204 or S206, if the process of registering the performance information of the target printer 2 in the HDD 14 is completed, it is determined at operation S207 whether the performance information of all the printers 2 is completely registered in the HDD 14.

If it is determined that the performance information of all the printers 2 is completely registered (S207: Yes), the operation of acquiring and registering the performance information of the target printer 2 ends, and the process proceeds to operation S105 shown in FIG. 3.

If it is determined that the performance information of all the printers 2 is not completely registered (S207: No), the process returns to operation S201, and operations S201 to S207 are performed on the next target printer 2.

If it is determined at operation S103 of FIG. 3 that the performance information of all the printers 2 is registered in the HDD 14 (S103: Yes) and it is determined at operation S207 of FIG. 4 that the performance information of all the printers 2 is completely registered in the HDD 14 (S207: Yes), the performance information of all the printers 2 including the third printer 2C is registered, and a performance information table shown in FIG. 5 is registered in the HDD 14. The performance information table is used in the subsequent process.

In the table shown in FIG. 5, numbers 1, 2, and 3 in the leftmost column correspond to the first printer 2A, the second printer 2B, and the third printer 2C, respectively. This table shows that, for example, with respect to the second printer 2B, a printing speed is 20 page per minute (ppm), a maximum printing resolution is 600 dot per inch (dpi), double-sided printing is available, and color printing is not available.

At operation S105, it is determined whether the condition information is registered. If it is determined that the condition information is registered (S105: Yes), it is determined at operation S106 whether it is necessary to set the condition information again.

If it is determined at operation S105 that the condition information is not registered (S105: No) or it is determined at operation S106 that it is necessary to set the condition information again (S106: Yes), the condition information is set at operation S107.

Setting the condition information is performed through the window shown in FIG. 6 while the user checks performance information for each degree of importance. FIG. 6 shows an example in which the first important performance information is ‘color printing capable’, the second important performance information is ‘printing speed’, and the third important performance information is ‘resolution’. In other words, user sets a plurality of condition information items such as ‘color printing capable’, ‘printing speed’ aid ‘resolution’ in this exemplary embodiment and sets the priority order of the condition information items.

In FIG. 6, ‘printing speed’, ‘resolution’, ‘double-sided printing capable’, and ‘color printing capable’ are shown as the condition information, but the conditions are not limited thereto. For example, the conditions may include ‘the size of a printing sheet’ and ‘N-in-1 printing capable’.

The condition information set in operation S107 is registered in the HDD 14 at operation S108.

If it is determined at operation S106 that it is not necessary to set the condition information again (S106: No) or after the condition information is set at operation S108, the condition information is compared with the performance information of the first to third printers 2A, 2B, and 2C at operation S109.

Next, an example of performance comparison at operation S109 when the first to third printers 2A, 2B, and 2C have the performance information as shown in FIG. 5 and the conditions included in the condition information are as shown in FIG. 6 will be described.

First, since the first important performance information is ‘color printing capable ’ in FIG. 6, the first printer 2A and the third printer 2C which can perform color printing are selected as candidates of a default printer based on the performance information shown in FIG. 5. Since the second printer 2B cannot perform color printing, the second printer is excluded from the candidate of the default printer based on the condition information shown in FIG. 6.

Then, since the second important performance information is ‘printing speed’ in FIG. 6, one of the first printer 2A and the third printer 2C selected by the previous determination, which has a higher printing speed is selected as the default printer. In this case, since the ‘printing speed’ of the third printer 2C is higher than that of the first printer 2A, the third printer 3C is selected as the default printer.

After the performance comparison at operation S109, an installation process on the printer driver of the third printer 2C which is an install target, such as a copy of a printer driver file, is performed at operation S110.

Then, at operation S111, the printer 2 selected at operation S109 is set as the default printer. Then, the installation process and the default printer setting process end.

In this way, it is possible to set an optimal default printer according to priority order of a plurality of condition information items. Even if a printer driver of a new printer 2 is added, it is possible to set an optimal default printer among a plurality of printers 2.

In this exemplary embodiment, three printers 2, that is, the first to third printers 2A, 2B, and 2C are connected, but the number of printers 2 is not limited to three.

In this exemplary embodiment, when the condition information is set, three performance information items, that is, the first to third important performance information items can be registered as condition information items, but the number of condition information items is not limited to three. When the number of printers 2 is increased, there may be printers 2 having similar performance information. Therefore, it is preferable to register a large amount of condition information in order to appropriately set a default printer.

### <Operation of Second Exemplary Embodiment>

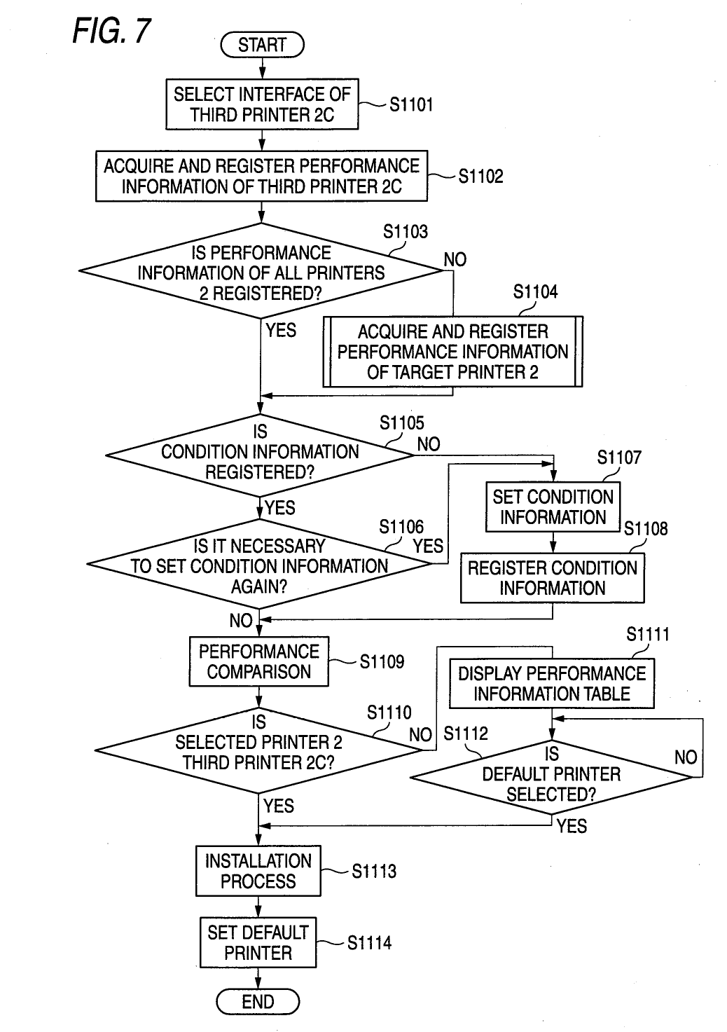

FIG. 7 is a flowchart illustrating a method of setting a default printer when a printer driver is installed according to a second exemplary embodiment.

An operation of setting a default printer according to the second exemplary embodiment will be described with reference to FIG. 7. In this exemplary embodiment, the printer drivers of the first printer 2A and the second printer 2B have already been installed in the PC 1 similarly to the first exemplary embodiment. In this case, an operation of installing a printer driver of the third printer 2C in the PC will be described below.

In the second exemplary embodiment, a description of the same operations as those in the first exemplary embodiment will be omitted, and only the operations different from those of the first exemplary embodiment will be described.

In the flowchart shown in FIG. 7, operations S1101 to S1109 is same as operations S101 to S109 in the flowchart shown in FIG. 3, respectively. Additionally, a method of acquiring and registering the performance information of the target printer 2 at operation S1104 is same as the process shown in FIG. 4 similarly to the first exemplary embodiment.

In the second exemplary embodiment, after the performance comparison in operation S1109, it is determined at operation S110 whether the printer 2 selected as the default printer is the third printer 2C, which is an install target. In other words, it is determined at operation S1110 whether the printer 2 determined as a candidate of the default printer is the install target printer. If it is determined that the printer 2 selected as the default printer is not the third printer 2C, which is an install target (S110: No), the performance information table shown in FIG. 5 is displayed (indicated) on the display 6 of the PC 1 at operation S1111.

Then, at operation S1112, the user selects one of the printers 2 as the default printer from the performance information table.

If it is determined at operation S1110 that the printer 2 selected as the default printer is the third printer 2C, which is an install target (S1110: Yes) or the selection of the default printer is completed at operation S1112, an installation process on the printer driver of the third printer 2C which is the install target, such as a copy of a printer driver file, is performed at operation S1113.

Then, at operation S1114, the printer 2 selected at operation S1110 or S1112 is set as the default printer. Then, the installation process and the default printer setting process end.

In this way, it is possible to select an optimal default printer from all the printers 2 connected to the PC 1.

In this exemplary embodiment, three printers 2, that is, the first to third printers 2A, 2B, and 2C are connected, but the number of printers 2 is not limited to three.

In this exemplary embodiment, if the condition information is set, three condition information items, that is, the first to third important performance information items can be registered, but the number of condition information items is not limited to three. When the number of printers 2 is increased, there may be printers 2 having similar performance information. Therefore, it is preferable to register a large amount of condition information in order to appropriately set a default printer.

### <Operation of Third Exemplary Embodiment>

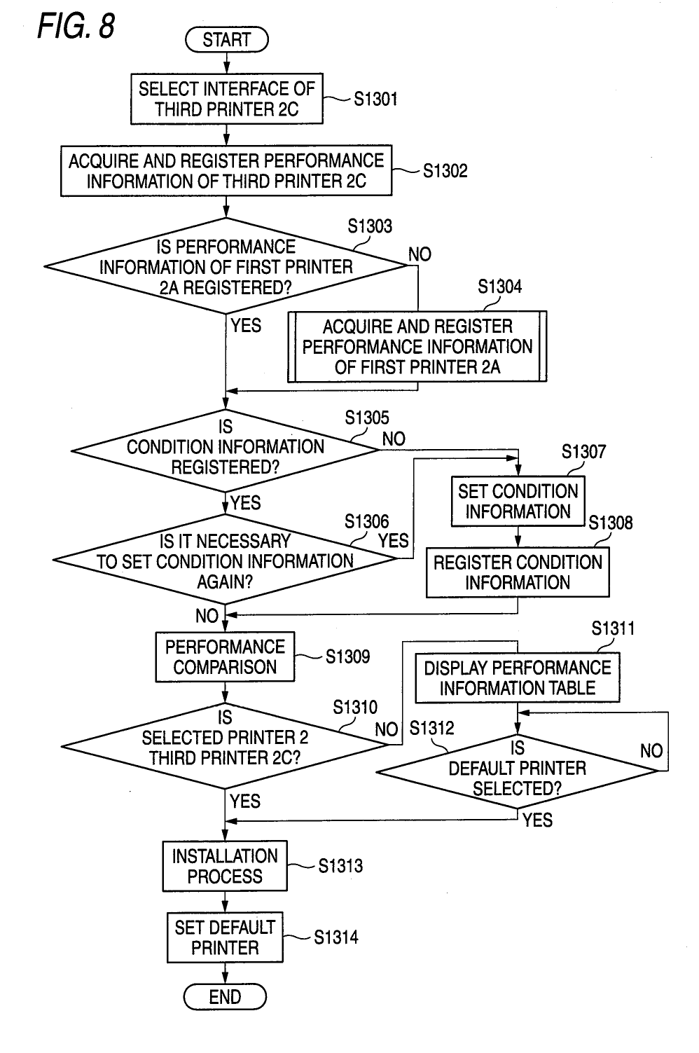

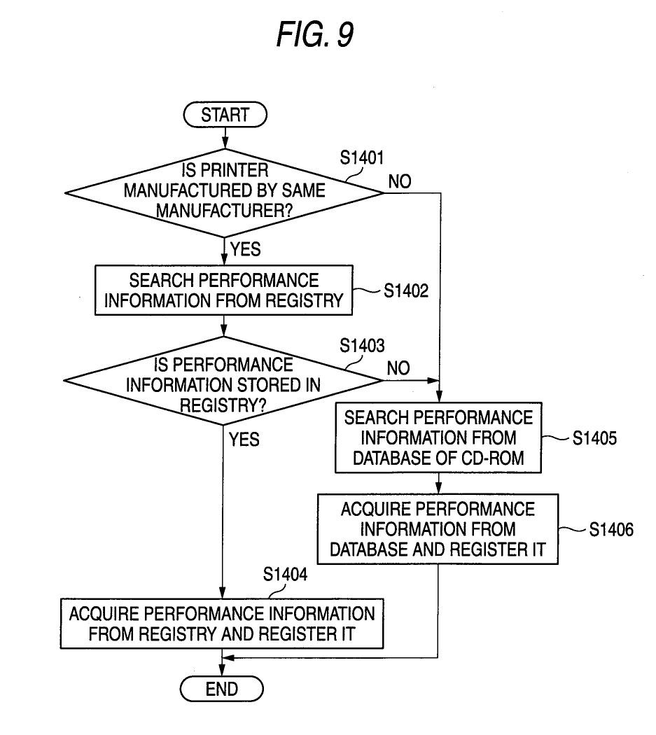

FIG. 8 is a flowchart illustrating a method of setting a default printer when a printer driver is installed according to a third exemplary embodiment. FIG. 9 is a flowchart illustrating a method of acquiring and registering the performance information of the first printer 2A according to the third exemplary embodiment.

An operation of setting a default printer according to the third exemplary embodiment will be described with reference to FIGS. 5, 6, 8 and 9. In this exemplary embodiment, the printer drivers of the first printer 2A and the second printer 2B have already been installed in the PC 1 similarly to the first and second exemplary embodiments. Additionally, the first printer 2A is set as the current default printer. In this case, an operation of installing a printer driver of the third printer 2C in the PC 1 will be described below.

In the third exemplary embodiment, a description of the same operations as those in the first or second exemplary embodiment will be omitted, and only the operations different from those of the first exemplary embodiment will be described.

In the flowchart shown in FIG. 8, operations S1301 to S1314 correspond to operations S1101 to S1114 in the flowchart shown in FIG. 7, respectively. In the flowchart shown in FIG. 9, operations S1401 to S1406 correspond to operation S201 to S206 in the flowchart shown in FIG. 4.

After operation S1301 ends, at operation S1302, the CPU 11 acquires performance information of the third printer 2C, and registers the acquired performance information in the HDD 14.

At operation S1303, it is determined whether the performance information of the first printer 2A, which is the current default printer, is registered in the HDD 14.

If it is determined that the performance information of the first printer 2A is not registered in the HDD 14 (S1303: No), at operation S1304, the performance information of the first printer 2A is acquired and registered.

A method of acquiring and registering the performance information of the first printer 2A at operation S1304 is shown in FIG. 9. First, at operation S1401, it is determined whether the first printer 2A is manufactured by the same manufacturer as the control apparatus and the program according to this exemplary embodiment.

If it is determined at operation S1401 that the first printer 2A is manufactured by the same manufacturer (S1401: Yes), at operation S1402, the performance information is searched from a registry of the control apparatus or the program.

Next, at operation S1403, it is determined whether the performance information of the first printer 2A is stored in the registry. If it is determined that the performance information is stored in the registry (S1403: Yes), at operation S1404, the performance information of the first printer 2A is acquired from the registry and then registered in the HDD 14.

If it is determined at operation S1401 that the first printer 2A is not manufactured by the same manufacturer (S1401: No) or it is determined at operation S1403 that the performance information of the first printer 2A is not stored in the registry (S1403: No), at operation S1405, information of the first printer 2A is searched from a database of a CD-ROM.

Then, at operation S1406, the information of the first printer 2A is acquired from the database of the CD-ROM, and then registered in the HDD 14.

At operation S1404 or S1406, when the process of registering the performance information of the first printer 2A, which is the current default printer, in the HDD 14 is completed, the operation of acquiring and registering the performance information of the first printer 2A ends, and the process proceeds to operation S1305 shown in FIG. 8.

If it is determined at operation S1303 of FIG. 8 that the performance information of the first printer 2A, which is the current default printer, is registered in the HDD 14 (S1303: Yes) or it is determined at operation S1404 or S1406 of FIG. 9 that the performance information of the first printer 2A is registered, registration of both of the performance information of the first printer 2A and the third printer 2C is completed, and the performance information table shown in FIG. 5 is registered in the HDD 14. The performance information table is used in the subsequent process. In this exemplary embodiment, only the performance information of the first printer 2A, which is the current default printer and the third printer 2C, a control program of which is an install target and to be installed newly, is registered in the performance information table shown in FIG. 5.

Then, at operations S1305 to S1309, similar to the first exemplary embodiment, the performance information of the first printer 2A and the third printer 2C is compared with the condition information shown in FIG. 6 to select a default printer.

Then, it is determined at operation S1310 whether the printer 2 selected as the default printer is the third printer 2C, which is an install target. If it is determined that the printer 2 selected as the default printer is not the third printer 2C, which is an install target (S1310: No), the performance information table shown in FIG. 5 is displayed (indicated) on the display 6 of the PC 1 at operation S1311.

Then, at operation S1312, the user selects one of the first and third printers 2A and 2C as the default printer from the performance information table.

If it is determined at operation S1310 that the printer 2 selected as the default printer is the third printer 2C, which is an install target, (S1310: Yes) and the selection of the default printer is completed at operation S1312, an installation process on the printer driver of the third printer 2C which is an install target and to be installed newly, such as a copy of a printer driver file, is performed at operation S1313.

Then, at operation S1314, the printer 2 selected at operation S1310 or S1312 is set as the default printer. Then, the installation process and the default printer setting process end.

In this way, it is possible to select, as the default printer, optimal one of the third printer 2C to be installed and the first printer 2A that is set as the current default printer among the printers 2 connected to the PC 1. In the third exemplary embodiment, only two printers, that is, the printer 2 that is set as an optimal default printer by the user and a printer to be installed are compared. Therefore, it is possible to effectively select a default printer.

In this exemplary embodiment, three printers 2, that is, the first to third printers 2A, 2B, and 2C are connected, but the number of printers 2 is not limited to three.

According to the above-described second and third exemplary embodiments, it is possible to appropriately set a default printer according to priority order in a plurality of condition information items. In addition, since the performance information table of the printer 2 is notified (indicated) to the user, the user can select a desired printer 2 as a default printer.

Even if a printer driver of a new printer 2 is added, an optimal default printer can be set among a plurality of printers 2. In addition, a process of automatically setting the third printer 2C to be installed as a default printer makes it possible to actively use a newly installed third printer 2C as a default printer.

### <Modifications>

While the present invention has been shown and described with reference to certain exemplary embodiments thereof, it will be understood by those skilled in the art that various changes in form and details may be made therein without departing from the spirit and scope of the invention as defined by the appended claims.

(1) In the first to third exemplary embodiments, the condition information is set at operation S107, S1107 and S1307. However, the condition information may be set at any time while an OS is being operated. According to this configuration, when a default printer is set, operations S107, S1107 and S1307 are omitted, and the time required to set a default printer is reduced.

(2) In the first to third exemplary embodiments, at operations S106, S1106 and S1306, it is determined whether it is necessary to set the condition information again. However, this operation may be omitted. According to this configuration, it is possible to use the previously set condition information without any change. As a result, it is possible to reduce the time required to set a default printer.

(3) In the second and third exemplary embodiments, when the condition information is set, the condition information is associated with a priority order, as shown in FIG. 6. However, the concept of priority order may not be used.

That is, when the third printer 2C to be installed has performance information satisfying all of a plurality of set condition information items, the third printer 2C may be automatically selected as a default printer at operations S1109 and S1110 or operations S1309 and S1310. On the other hand, when the third printer 2C has performance information not satisfying all the condition information items, the default printer may be selected by the user in operation S1110 to S1112 and operations S1310 to S1312. Alternatively, a printer having performance information which matches the condition information items by a largest number among the printers 2 may be selected as a default printer at operations S1109 and S1110 or operations S1309 and S1310.

(4) In the second and third exemplary embodiments, the condition information is set at operations S1105 to S1108 and operations S1305 to S1308. However, the condition information may be set in advance. That is, the condition information may be set in advance by a printer driver manufacturer.

(5) In the second and third exemplary embodiments, the condition information is set at operations S1105 to S1108 or operations S1305 to S1308, performance comparison is performed at S1109 or S1309, and it is determined at operation S1110 or S1310 whether the printer 2 selected as a default printer is the third printer 2C, which is an install target. However, operations S1105 to S1110 and operations S1305 to S1310 may be omitted.

That is, the following configuration may be used: at operations S1103 and S1104 or operations S1303 and S1304, the performance information of all the printers 2, or the performance information of the first printer 2A, which is the current default printer and the performance information of the third printer 2C, which is an install target printer 2, are registered to make the performance information table shown in FIG. 5; at operations S111 and S1311, the performance information table is displayed (indicated) on the display 6 of the PC 1; and at operation S1112 or S1312, the user selects one of the printers 2 as a default printer.

(6) In the first to third exemplary embodiments, the default printer is set during installation, but the timing of setting the default printer is not limited thereto. For example, while the OS is being operated, the default printer may be set by an application according to an exemplary embodiment of the present invention.

(7) In the first to third exemplary embodiments, as the storage units of the PC 1, the ROM 12, the RAM 13, and the HDD 14 are used, but the storage units are not limited thereto. For example, other storage units, such as an NVRAM, may be used.

(8) In the first to third exemplary embodiments, the acquired performance information of the printer 2 is stored in the HDD 14. However, the acquired performance information may be stored in the RAM 13 or other storage units, such as an NVRAM.

(9) In the first to third exemplary embodiments, in the example of performance comparison shown in FIG. 6, there is a printer 2 having the conditions satisfying both the first important performance and the second important performance. However, there may be no printer 2 having the conditions satisfying both the first important performance and the second important performance. In this case, setting of the condition information may be required to the user again. If some performances are not satisfied, only the performances satisfying the conditions may be used to set the default printer.

(10) In the first to third exemplary embodiments, a printer is given as an example of a device, but the device is not limited to the printer. The inventive concept of the present invention can be applied to any control system in which some devices having the same functions as described above are connected to the PC 1. The device may be a multi-function machine, a FAX, a copying machine, and a scanner. This is similarly applied to the default printer according to the above-described exemplary embodiments.

(11) In the second and third exemplary embodiments, the mouse 4 and the keyboard 5 are used to select a default device. Additionally, a pointing device, such as a stylus pen, or a trackball or a touch pad generally provided in a notebook PC, may be used.

(12) In the first to third exemplary embodiments, location information of the printers 2, which indicates where the printers are provided may be registered in the HDD 14 similarly to the performance information. In this case, condition information may include location information and may be compared with the location information stored in the HDD 14 to select the default printer.

What is claimed is:

1. A control apparatus comprising:
a performance storage unit which stores performance information of a device corresponding to an installed control program;
a setting unit which sets condition information for a default device;
a condition storage unit which stores the condition information set by the setting unit;
a comparing unit which compares the condition information stored in the condition storage unit with the performance information stored in the performance storage unit; and
a selecting unit which selects the default device based on a comparison result of the comparing unit.

2. The control apparatus according to claim 1,
wherein the performance storage unit stores performance information of a plurality of devices.

3. The control apparatus according to claim 1,
wherein the setting unit sets a plurality of condition information items for the default device as the condition information.

4. The control apparatus according to claim 1,
wherein the selecting unit selects the default device in response to that the control program is installed.

5. The control apparatus according to claim 2,
wherein the comparing unit compares the condition information stored in the condition storage unit with the performance information of the plurality of devices, and
wherein the selecting unit selects one of the plurality of devices as the default devices based on the comparison result of the comparing unit

6. The control apparatus according to claim 3,
wherein the setting unit sets an order of the plurality of condition information items, and
wherein the comparing unit compares the plurality of condition information items with the performance information in the set order.

7. The control apparatus according to claim 3,
wherein the performance storage unit stores performance information of a plurality of devices,
wherein the comparing unit compares the plurality of condition information items with the performance information of the plurality of devices, and
wherein the selecting unit selects a device having performance information which matches the plurality of condition information items by a largest number among the plurality of devices.

8. The control apparatus according to claim 1,
wherein the performance information of the device indicates at least one of a printing speed, a maximum printing resolution, a size of a printing sheet, capability of color printing, capability of double-sided printing, and capability of N-in-l printing with respect to the device.

9. A computer-readable medium having a computer program stored thereon and readable by a computer including a performance storage unit which stores performance information of a device corresponding to a control program installed in the computer, and a condition storage unit which stores condition information for a default device, the computer program, when executed by the computer, causing the computer to perform operations comprising:
setting the condition information and storing in the condition storage unit;
comparing the condition information stored in the condition storage unit with the performance information stored in the performance storage unit; and
selecting the default device based on a result of the comparing.

10. A control apparatus comprising:
a performance storage unit which stores performance information of a plurality of devices;
an indicating unit which indicates the performance information; and
a selecting unit which selects, based on an input from an outside, a default device from among the plurality of devices, the performance information of which is indicated by the indication unit.

11. The control apparatus according to claim 10,
wherein the indication unit indicates only the performance information of a device which is selected as a current default device and the performance information of a device corresponding to a control program to be installed newly.

12. The control apparatus according to claim 10,
wherein the indication by the indication unit and the selection of the default device by the selecting unit are performed when a control program for controlling a device is installed.

13. The control apparatus according to claim 11, further comprising:
a setting unit which sets condition information for the default device;
a condition storage unit which stores the condition information set by the setting unit;
a comparing unit which compares the condition information stored in the condition storage unit with the performance information stored in the performance storage unit; and
an automatic selecting unit which determines one of the devices as a candidate of the default device based on a comparison result of the comparing unit, and which selects the one of the devices as the default devices if the one of the devices corresponds to the control program to be installed newly.

14. The control apparatus according to claim 13,
wherein if the one of the devices determined as the candidate of the default device does not correspond to the control program to be installed newly, the indicating unit indicates the performance information.

15. A computer-readable medium having a computer program stored thereon and readable by a computer including a performance storage unit which stores performance information of a plurality of devices, the computer program, when executed by the computer, causing the computer to perform operations comprising:
indicating the performance information; and
selecting, based on an input from the outside, a default device from among the plurality of devices, the performance information of which is indicated by the indicating.
